(19) United States
(12) Patent Application Publication
(10) Pub. No.: US 2016/0125403 A1
(43) Pub. Date: May 5, 2016

(54) OFFLINE VIRTUAL CURRENCY TRANSACTION

(71) Applicants: Chin-hao Hu, New Taipei City (TW); Pai-tsung Hsu, New Taipei City (TW)

(72) Inventors: Chin-hao Hu, New Taipei City (TW); Pai-tsung Hsu, New Taipei City (TW)

(21) Appl. No.: 14/930,471

(22) Filed: Nov. 2, 2015

Related U.S. Application Data
(60) Provisional application No. 62/074,019, filed on Nov. 1, 2014.

(51) Int. Cl. G06Q 20/38; G06Q 20/06; G06Q 20/40

(52) U.S. Cl. CPC G06Q 20/38215; G06Q 20/3823; G06Q 20/3829; G06Q 20/401; G06Q 20/0658; G06Q 2220/00

(57) ABSTRACT

A method of conducting an offline virtual currency transaction is disclosed. The method may include steps of generating one or more virtual wallets; depositing certain amount of virtual currency in said virtual wallets; a payer transmitting at least a portion of said virtual currency to a payee through an offline platform; and payee confirming reception of the virtual currency. In one embodiment, the step of transmitting at least a portion of said virtual currency to another user through an offline platform may include a step of scanning a QR (Quick Response) code to transmit the virtual currency. In another embodiment, the virtual currency can also be transmitted through infrared. In a further embodiment, the step of confirming reception of the virtual currency may include a step of said payee deleting private key.

### CROSS-REFERENCE TO RELATED APPLICATIONS

This application claims priority under 35 U.S.C. §119 (e) to U.S. Provisional Patent Application Ser. No. 62/074,019, filed on Nov. 1, 2014, which is a continuous-in-part application from Ser. No. 14/263,850, filed on Apr. 28, 2014, the entire contents of which are hereby incorporated by reference.

### FIELD OF THE INVENTION

The present invention relates generally to an apparatus, system and method of payment transaction, and more particularly to an offline payment transaction using virtual currency.

### BACKGROUND OF THE INVENTION

The virtual world typically includes an environment with a variety of virtual locations having a variety of virtual objects. In the virtual world, virtual economies are emerging as important aspects of many Internet games and are actually becoming linked with the real world because players of the Internet games may spend real money to buy and sell virtual assets.

Many business entities issue various network virtual currencies to motivate customers and increase their loyalty, as well as Internet game operators who issue many kinds of virtual currencies as common currencies in game worlds. Actually, current network virtual currencies have been widely used in the Internet, for example, they are used to exchange gifts, services, flight tickets, even as the salary paid to the BBS board owner. One of the American economists predicts the future virtual economy: “within the daily global financial transactions, only 2% are related to real economy. From 2050, web-based virtual currency will be officially recognized to some extent, and become liquid common currency.” Network virtual currency market is becoming bigger and bigger, and many business opportunities emerge in this area.

Virtual currency systems enable users to interact in the virtual environment by transacting with other entities therein. Users may exchange virtual credits for a variety of different purposes, such as a purchase of goods or services from a vendor or a gift or payment between individuals. In some systems, virtual credits can also be exchanged for real currency, such as purchasing virtual credits with real currency and/or redeeming virtual credits for real currency.

Bitcoins are a form of internet currency. Bitcoins are intangible virtual coins in the form of a file that may be stored on a computer or a computer-related device. Specifically, a Bitcoin (“BTC”) is a unit of currency of a peer-to-peer system that is not regulated by any central or governmental authority. Rather, the regulation of Bitcoins (i.e., the issuance of new Bitcoins and the tracking of transactions involving Bitcoins) may be accomplished collectively by the network of people and businesses that conduct business with Bitcoins.

Current virtual currency transactions (including Bitcoin transactions) as stated above are conducted through networks, mostly through the internet. For example, U.S. Pat. No. 8,255,297 to Morgenstern et al. discloses a virtual currency system that keeps track of virtual credits, which can be owned, transferred, purchased, and sold by participants in a virtual economy. As shown in FIG. 1, the system relies on an external network (201) connecting with user devices (210) to communicate with a server (230). Likewise, U.S. Pat. No. 8,453,219 to Shuster et al. discloses systems and methods of virtual world interaction, operation, implementation, instantiation, creation, and other functions related to virtual worlds, as shown in FIG. 2. As can be seen in both FIGS. 1 and 2, if the user devices wish to communicate with each other, they have to communicate through the network, and it would be inconvenient for the users when the transaction is so needed, but the network (e.g. internet) is not available. Therefore, there remains a need for an offline virtual currency transaction to overcome the problems stated above.

### SUMMARY OF THE INVENTION

It is an object of the present invention to provide an offline virtual currency transaction system, so the users can conduct virtual currency transactions without external networks.

It is another object of the present invention to provide an offline virtual currency transaction system, so that the users can conduct offline virtual currency transactions through mobile devices.

It is a further object of the present invention to provide an offline virtual currency transaction system to facilitate virtual transactions.

In one aspect, a method of conducting an offline virtual currency transaction, which comprises steps of generating one or more virtual wallets; depositing certain amount of virtual currency in said virtual wallets; a payer transmitting at least a portion of said virtual currency to a payee through an offline platform; and payee confirming reception of the virtual currency.

In one embodiment, the step of transmitting at least a portion of said virtual currency to another user through an offline platform 130 may include a step of scanning a QR (Quick Response) code to transmit the virtual currency. In another embodiment, the virtual currency can also be transmitted through infrared, sonic wave or WIFI AD-HOC. In a further embodiment, the step of confirming reception of the virtual currency may include a step of said payee deleting private key.

The method of conducting an offline virtual currency transaction may further include a step of the payee depositing the virtual currency into the payee's virtual wallet.

In another aspect, a system for conducting an offline virtual currency transaction may include a first user interface that is used to generate one or more first virtual wallets containing virtual currencies; and a second user interface that is used to receive at least a portion of the virtual currencies offline from the first user interface, wherein said first user interface converts said first virtual wallets into a cryptographic element and the second user interface is configured to decrypt said cryptographic element to retrieve the virtual currencies in the first virtual wallets.

In one embodiment, the first/second user interface is an electronic device such as a computer, a cellular phone and a tablet. In another embodiment, the first virtual wallets are generated online by said first user interface.

In a further embodiment, the cryptographic element is a QR (Quick Response) code. In still a further embodiment, the first user interface may include a transmitting unit to transfer the virtual currencies to the second user interface through infrared, sonic wave or WIFI AD-HOC.

In another aspect, a web service is configured to generate a pair of asymmetric crypto keys, and a mobile device is also configured to generate asymmetric crypto keys for communicating with the web service. More specifically, the mobile device has a corresponding mobile account on the web service, and the mobile device has to login to the corresponding mobile account on the web service via a mobile account login package. In one embodiment, the mobile account login package may include a device-encoded mobile account name, mobile account password, mobile device date/time. The mobile account login package may further include a device decoding key (or mobile verification data) which is used to verify the mobile account login package written by the mobile device.

When the mobile device login, the web service can then respond to whether the login is successful or not. Namely, this step verifies that the device decoding key (or the mobile verification data) works and authenticates the account credential of the mobile account.

Upon successful authentication, the mobile device can receive the data from the web service, including the server decoding key (or server verification data) and a server authorizing package that contains server-encoded mobile account name, expiration date of the mobile decoding key (or mobile verification data) and the device decoding key (or mobile verification data). It is noted that a mobile account balance and the server decoding key are sent to the mobile device to prevent fake device decoding key.

The mobile device is configured to verify whether the decoding is successful and stores the entire server authentication package that verifies the server decoding key (or server verification data). It is noted that the payee mobile device will be configured with server following the steps stated above, which means the mobile device should have its own server authorizing package.

In a further embodiment illustrating a transaction, a payee mobile device (payee) is configured to send the following information to the payer device: (i) payee's device decoding key (or payee's mobile verification data); and (ii) device encoded mobile device request pay package, which may include payee's server authorizing package, amount, transaction date and transaction meta data; and the mobile device verifies the payee's server authorizing package with the server decoding key (or server verification data). And the mobile device is configured to send the following information to payee's mobile device: (i) payer's device decoding key (or payer's mobile verification data); and (ii) device encoded mobile device pay package, which may include payee's encoded mobile device request pay package, and payer's server authorizing package. It is noted that the transaction between the payee device and payer device can be conducted offline.

### BRIEF DESCRIPTION OF THE DRAWINGS

FIG. 1 is a prior art disclosing a virtual currency system that keeps track of virtual credits, which can be owned, transferred, purchased, and sold by participants in a virtual economy.

FIG. 2 is a prior art disclosing systems and methods of virtual world interaction, operation, implementation, instantiation, creation, and other functions related to virtual worlds.

FIG. 3 is a prior art illustrating Bitcoin transactions.

FIG. 4 illustrates a method of method of conducting an offline virtual currency transaction in the present invention.

FIGS. 5-8 illustrate a system for conducting an offline virtual currency transaction in the present invention.

FIG. 9 is a schematic block diagram for an offline transaction between two mobile devices and a web server.

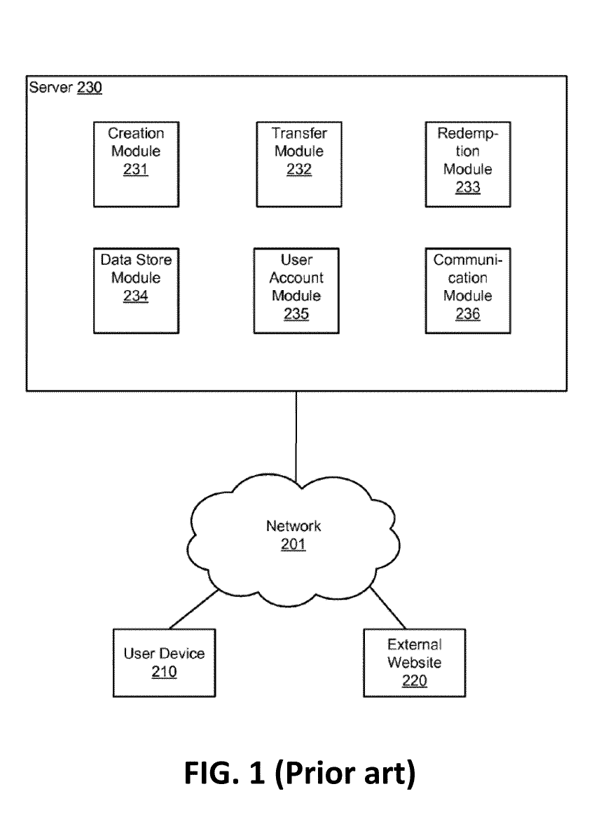

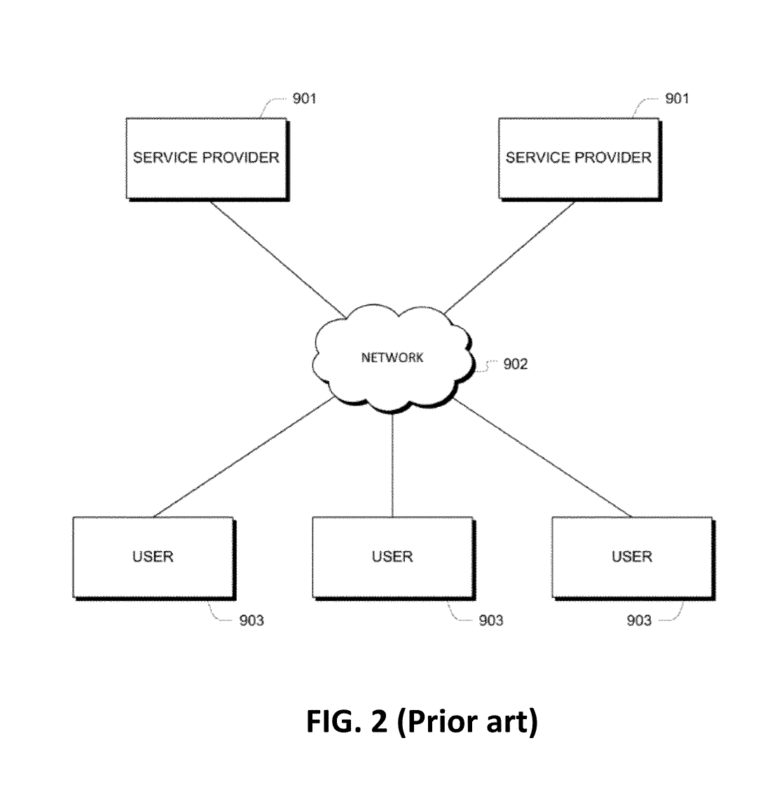

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As discussed above, the environment in the virtual world may be governed, at least in part, by a virtual economy, which typically involves the exchange of virtual currency for real and virtual goods and services. Bitcoins which are intangible virtual coins in the form of a file that may be stored on a computer or a computer-related device, become more and more popular recently. Specifically, Bitcoin uses a peer-to-peer system that is not regulated by any central or governmental authority and enables instant payment to anyone, anywhere in the world.

Bitcoin, introduced in 2009, is called a cryptocurrency. When paying with Bitcoin, no actual monetary exchange takes place between a buyer and a seller. Instead, the buyer requests an update to a public transaction log, the “block chain.” The block chain is a shared public ledger on which the entire Bitcoin network relies and all confirmed transactions are included in the block chain. So, a spendable balance can be calculated in Bitcoin wallets and new transactions can be verified. The integrity and the chronological order of the block chain are enforced with cryptography.

A Bitcoin transaction is a transfer of value between Bitcoin wallets in the block chain. Bitcoin wallets keep a secret piece of data called a private key, which is used to sign transactions, providing a mathematical proof that the signed transactions come from the owner of the wallet. The signature also prevents the transaction from being altered by anybody once it has been issued. All transactions are broadcast between users and usually begin to be confirmed by the network in the following 10 minutes, through a process called mining.

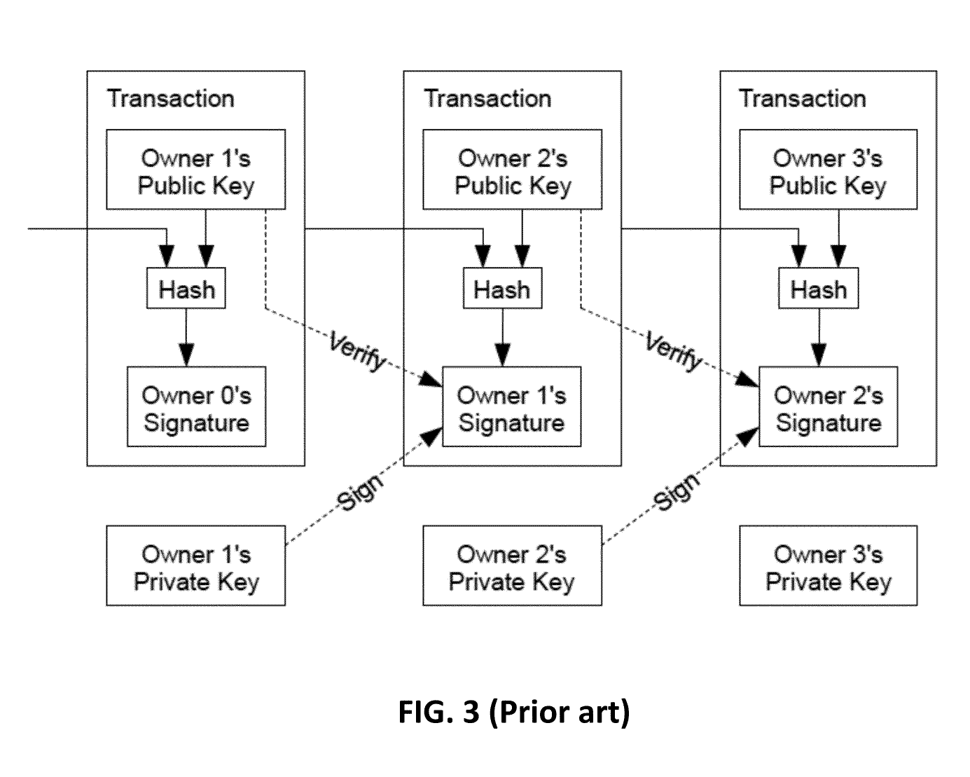

In a nutshell, as shown in FIG. 3, Bitcoin basically functions with one public-key pairing with one private key, and a collection of keys is called Bitcoin wallets. Addresses to which payments can be sent are derived from public keys by application of a hash function and encoding scheme. The corresponding private keys act as a safeguard and a valid payment message from an address must contain the associated public key and be digitally signed by the associated private key. Because anyone with a private key can spend all of the Bitcoins associated with the corresponding address, the essence of Bitcoin security is protection of private keys. However, all these transactions have to be conducted online.

The mining process employs a distributed consensus system that is used to confirm waiting transactions by including them in the block chain. It enforces a chronological order in the block chain, protects the neutrality of the network, and allows different computers to agree on the state of the system. To be confirmed, transactions must be packed in a block that fits very strict cryptographic rules that will be verified by the network. These rules prevent previous blocks from being modified because doing so would invalidate all following blocks. Mining also creates the equivalent of a competitive lottery that prevents any individual from easily adding new blocks consecutively in the block chain. This way, no individuals can control what is included in the block chain or replace parts of the block chain to roll back their own spends.

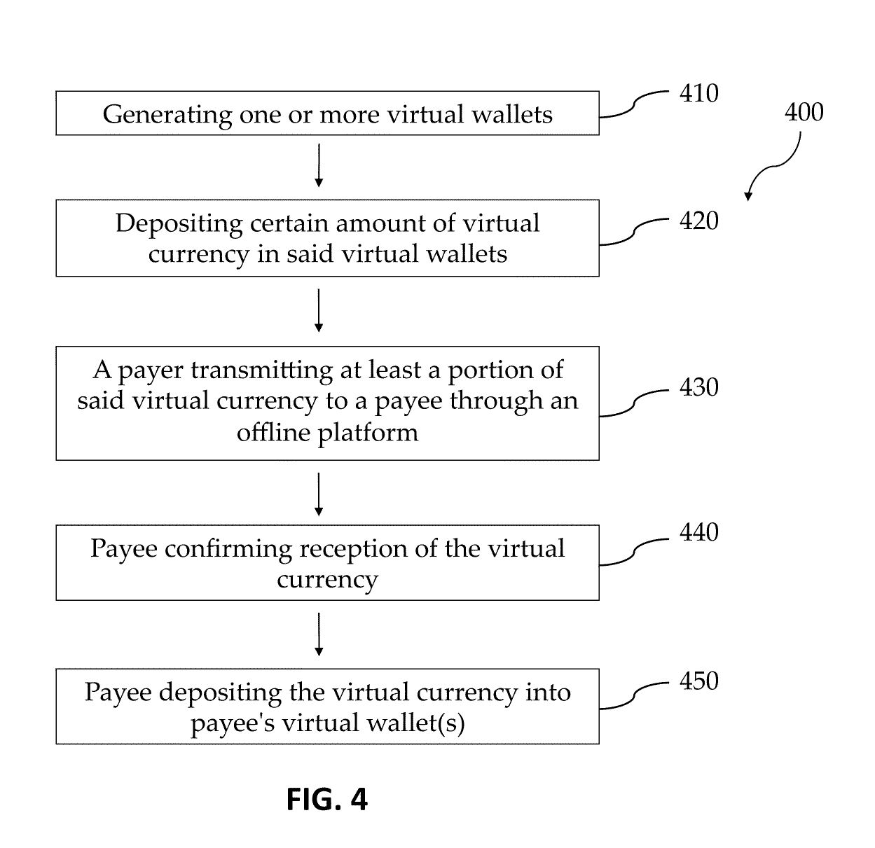

In one aspect, the present invention provides a method of conducting an offline virtual currency transaction 400, which comprises steps of: generating one or more online wallets 410; depositing certain amount of virtual currency in said online wallets 420; a payer transmitting at least a portion of said virtual currency to a payee through an offline platform 430; and said payee confirming reception of the virtual currency 440, as shown in FIG. 4.

In one embodiment, the step of transmitting at least a portion of said virtual currency to another user through an offline platform 430 may include a step of scanning a QR (Quick Response) code to transmit the virtual currency. In another embodiment, the virtual currency can also be transmitted through infrared, sonic wave or WIFI AD-HOC. As stated above, Bitcoin basically functions with one public-key pairing with one private key. In a further embodiment using Bitcoins as the virtual currency in the present invention, the step of confirming reception of the virtual currency 440 may include a step of said payee deleting the payer's private key. The method of conducting an offline virtual currency transaction 400 may further include a step of payee depositing the virtual currency into payee's online wallet 450.

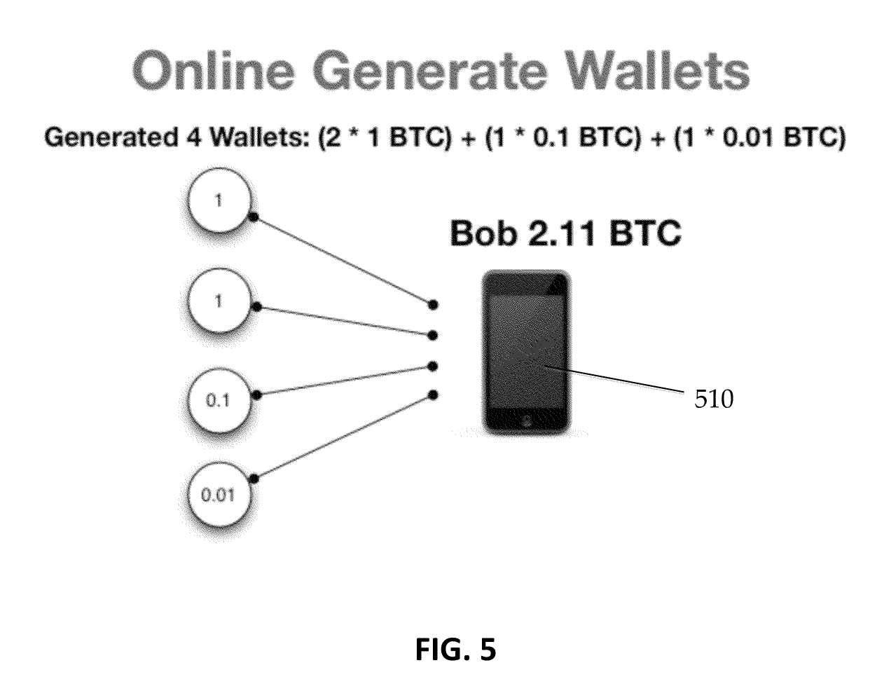

For example, as can be seen in FIGS. 5 to 8, a payer Bob can create one or more virtual wallets online to store the virtual currency therein. In one embodiment, the wallets can be created through a mobile device such as cellular phones or tablets. In other embodiments, the wallets can be created through computers or the like. In an exemplary embodiment, bitcoins (BTC) are used as the virtual currency. As shown in FIG. 5, 2.11 BTC can be deposited into four virtual wallets through a mobile phone 510.

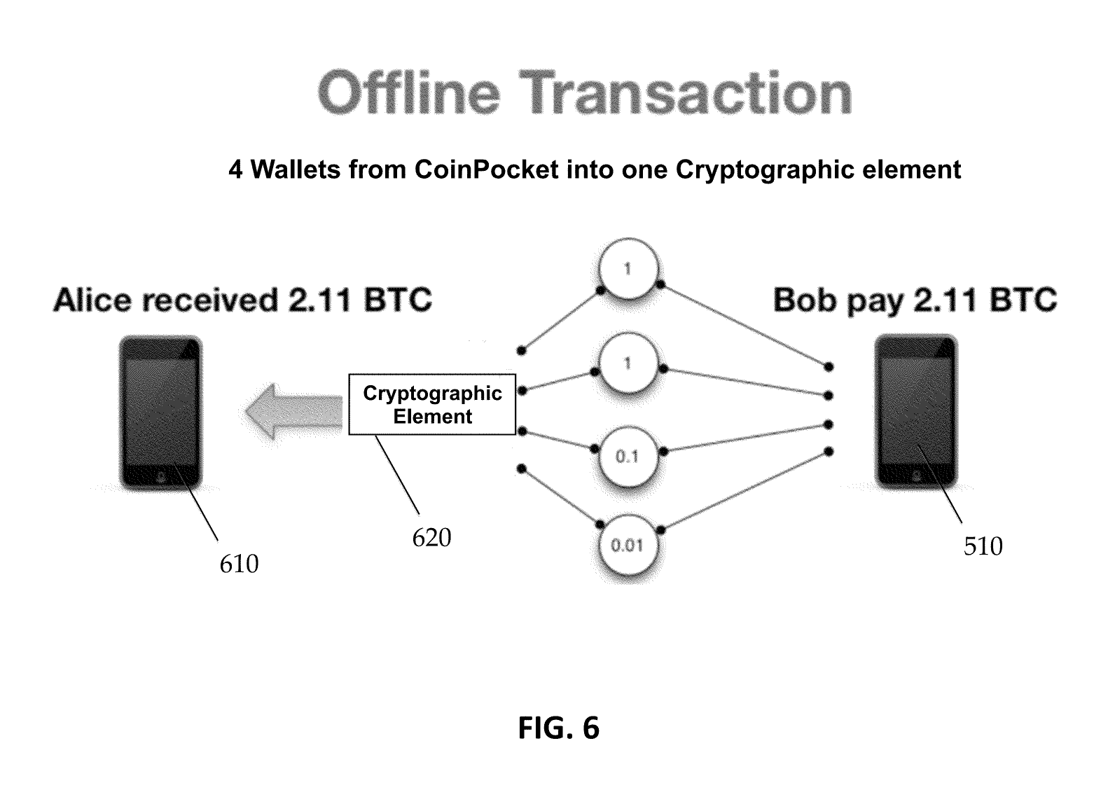

As illustrated in FIG. 6, the 2.11 BTC can be transmitted to a payee Alice through an offline platform. More specifically, a cryptographic element 620 can be generated on a payer's mobile device 510 including the amount of virtual currency that the payer wants to pay, and the payee can simply obtain the cryptographic element 620 from the payee's mobile device 610 to receive the virtual currency. In one embodiment, the cryptographic element 620 is a QR code. It is noted that the transmission of the virtual currency is completely an offline transmission.

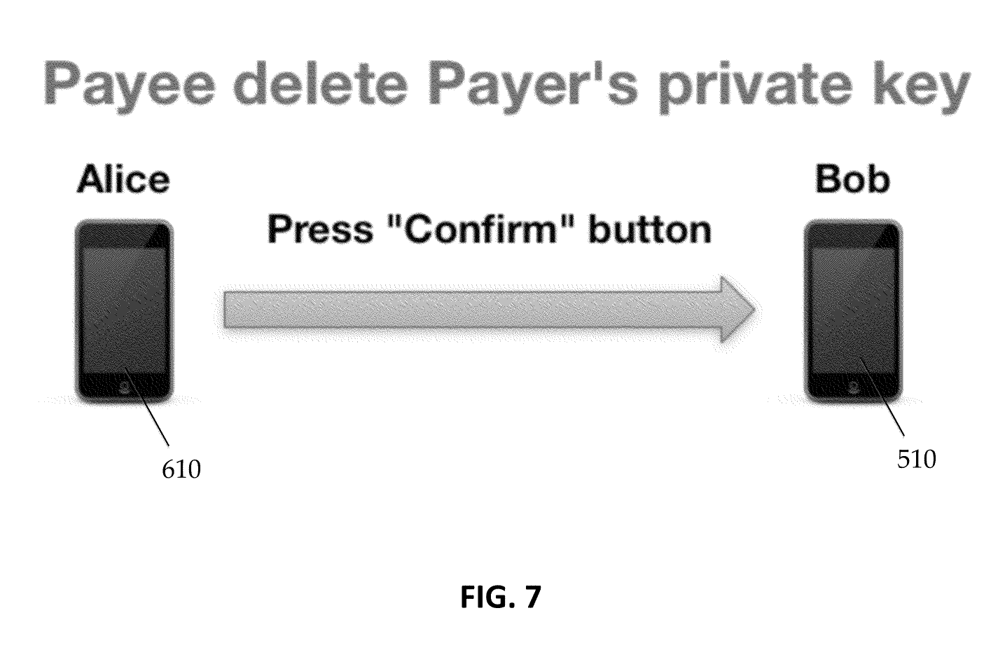

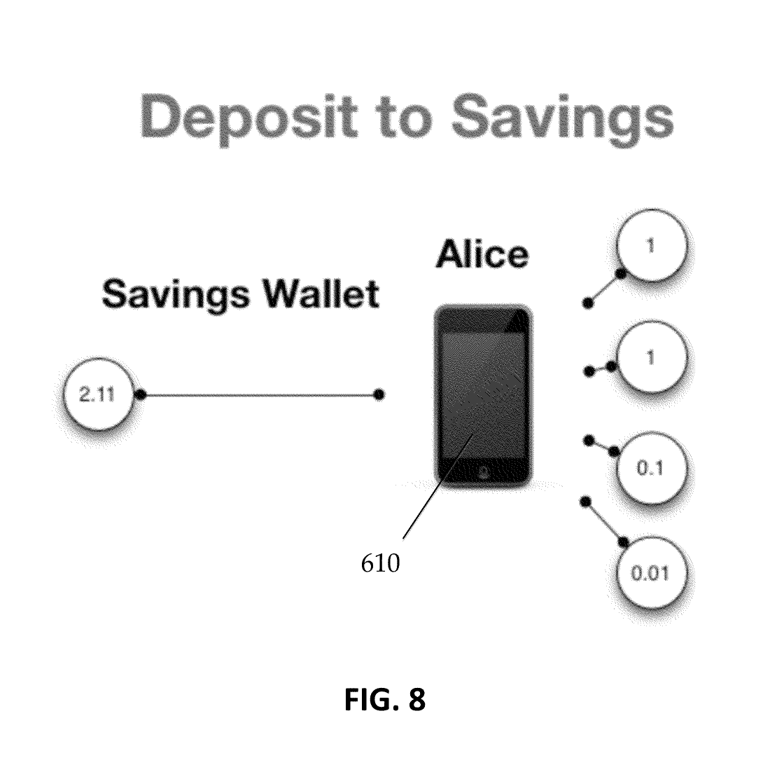

As stated above, a private key in the context of Bitcoin is a secret number that allows the Bitcoins to be spent. Every Bitcoin address has a matching private key, which is saved in the virtual wallet file of the person who owns the balance. The private key is mathematically related to the Bitcoin address, and is designed so that the Bitcoin address can be calculated from the private key, but importantly, the same cannot be done in reverse. In other words, the private key is the “ticket” that allows someone to spend Bitcoins. In an exemplary embodiment shown in FIG. 7, the payer's private key can be deleted by the payee if the payee presses the “confirm” button, so that the payee is authorized to spend the Bitcoins. The payee can further deposit the received Bitcoins as shown in FIG. 8.

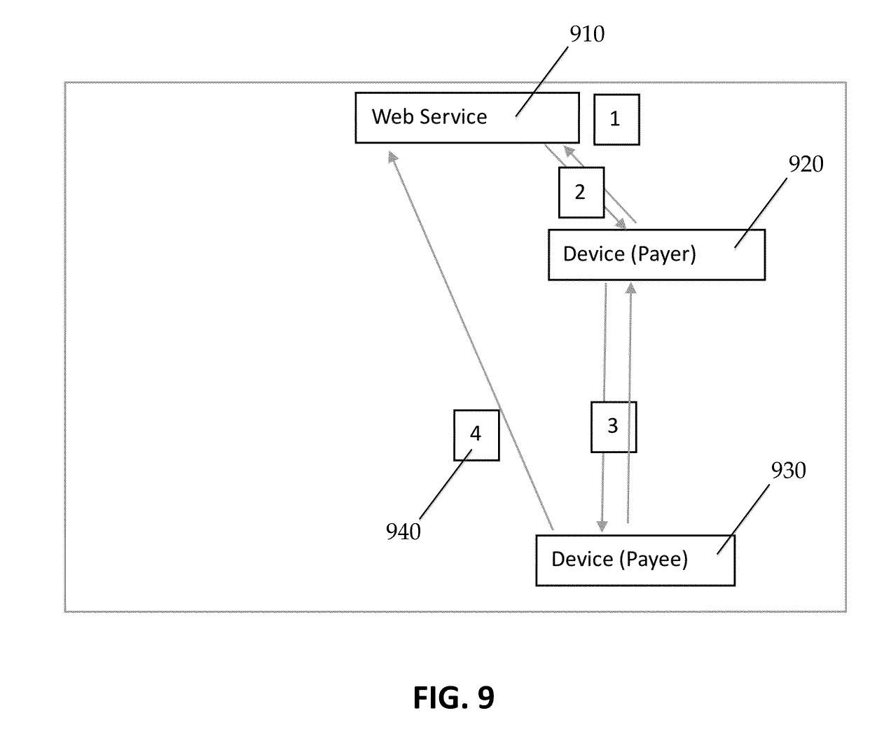

Referring to FIG. 9 for another aspect, a web service 910 is configured to generate a pair of asymmetric crypto keys, and a mobile device 920 is also configured to generate asymmetric crypto keys for communicating with the web service 910. More specifically, the mobile device 920 has a corresponding mobile account on the web service 910, and the mobile device 920 has to login to the corresponding mobile account on the web service 910 via a mobile account login package. In one embodiment, the mobile account login package may include a device-encoded mobile account name, mobile account password, mobile device date/time. The mobile account login package may further include a device decoding key (or mobile verification data) which is used to verify the mobile account login package written by the mobile device 920.

When the mobile device 920 login, the web service 910 can then respond to whether the login is successful or not. Namely, this step verifies that the device decoding key (or the mobile verification data) works and authenticates the account credential of the mobile account.

Upon successful authentication, the mobile device can receive the data from the web service 910, including the server decoding key (or server verification data) and a server authorizing package that contains server-encoded mobile account name, expiration date of the mobile decoding key (or mobile verification data) and the device decoding key (or mobile verification data). It is noted that a mobile account balance and the server decoding key are sent to the mobile device to prevent fake device decoding key.

The mobile device 920 is configured to verify whether the decoding is successful and stores the entire server authentication package that verifies the server decoding key (or server verification data). It is noted that the payee mobile device 930 will be configured with server following the steps from paragraphs [0034] to [0037] as well, which means the mobile device 930 should have its own server authorizing package.

In a further embodiment illustrating a transaction, a payee mobile device 930 (payee) is configured to send the following information to the payer device 920: (i) payee's device decoding key (or payee's mobile verification data); and (ii) device encoded mobile device request pay package, which may include payee's server authorizing package, amount, transaction date and transaction meta data; and the mobile device 920 verifies the payee's server authorizing package with the server decoding key (or server verification data). And the mobile device 920 is configured to send the following information to payee's mobile device 930: (i) payer's device decoding key (or payer's mobile verification data); and (ii) device encoded mobile device pay package, which may include payee's encoded mobile device request pay package, and payer's server authorizing package. It is noted that the transaction between the payee device 930 and payer device 920 can be conducted offline.

In still a further embodiment, a verifying mechanism 940 is configured to verify the transaction between devices 920 and 930 by checking the payer's server authorizing package to prevent fake server decoding key and device decoding key. More specifically, once device 930 (payee) is connected, it sends the payer's encoded mobile device pay package to the web server, which can check both server authorizing package in the pay package.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A system for offline virtual currency transaction comprising a web service platform, a first mobile device, a second mobile device and a verifying unit, wherein the web service platform is configured to generate a first set of asymmetric crypto keys and the first mobile device is configured to generate a second set of asymmetric crypto keys for communicating with and login the web service platform, and the web service platform is configured to send the first mobile device a first mobile verification data to verify whether the login of the first mobile device is authenticated;
wherein the web service platform is configured to generate a third set of asymmetric crypto keys and the second mobile device is configured to generate a fourth set of asymmetric crypto keys for communicating with and login the web service platform, and the web service platform is configured to send the second mobile device a second mobile verification data to verify whether the login of the second mobile device is authenticated;
wherein the second mobile device is configured to send the second mobile verification data and a first encoded pay package to the first mobile device, which includes the second device's server authorizing package, amount, transaction date and transaction meta data, so the first mobile device is configured to verify the second device's server authorizing package with the second mobile verification data;
wherein the first mobile device is configured to send the first mobile verification data, the first encoded pay package, and a first device's server authorizing package to the second mobile device, and wherein the verifying unit is configured to verify the transaction between the first mobile device and second mobile device.

2. The system for offline virtual currency transaction of claim 1, wherein the transaction between the first mobile device and second mobile device is an offline transaction.
